(19) United States
(12) Patent Application Publication
(10) Pub. No.: US 2022/0315697 A1
(43) Pub. Date: Oct. 6, 2022

(54) METHOD FOR PREPARING POLYETHER CARBONATE ALCOHOLS

(71) Applicants: Covestro Deutschland AG, Leverkusen (DE); Covestro Intellectual Property GmbH & Co. KG, Leverkusen (DE)

(72) Inventors: Aurel Wolf, Wülfrath (DE); Stefan Westhues, Leverkusen (DE); Mike Schuetze, Leverkusen (DE); Christoph Guertler, Köln (DE)

(21) Appl. No.: 17/625,539

(22) PCT Filed: Aug. 12, 2020
(86) PCT No.: PCT/EP2020/072580

§ 371 Date: Jan. 7, 2022

(30) Foreign Application Priority Data
Aug. 19, 2019 (EP) 19192407.5
Feb. 24, 2020 (EP) 20158920.7

(51) Int. Cl. C08G 65/26; C08G 18/44; C08G 64/02; C08G 64/30

(52) U.S. Cl. CPC C08G 65/2648; C08G 18/44; C08G 64/0208; C08G 64/305

(57) ABSTRACT

A method for preparing polyether carbonate alcohols by attaching cyclic carbonate to an H-functional starter substance in the presence of a catalyst, characterized in that a tribasic alkali- or alkaline earth metal phosphate is used as the catalyst, the alkali metal being selected from potassium or cesium.

### CROSS REFERENCE TO RELATED APPLICATIONS

This application is a U.S. national stage application, filed under 35 U.S.C. § 371, of International Application No. PCT/EP2020/072580, which was filed on Aug. 12, 2020, and which claims priority to European Patent Application No. 20158920.7 which was filed on Feb. 24, 2020, and to European Patent Application No. 19192407.5 which was filed on Aug. 19, 2019. The contents of each are hereby incorporated by reference into this specification.

### FIELD

The present invention relates to a process for preparing polyether carbonate alcohols, preferably polyether carbonate polyols, by catalytic addition reaction of cyclic carbonates onto an H-functional starter substance.

### BACKGROUND

It is known that cyclic carbonates, for example cyclic ethylene carbonate or propylene carbonate, may be used as a monomer in the preparation of polyether carbonate alcohols. Typically employed catalysts for this reaction are titanium compounds, such as titanium dioxide or titanium tetrabutoxide (EP 0 343 572), tin compounds, such as tin dioxide or dibutyltin oxide (DE 2 523 352), or alkali metal carbonates or acetates (DE 1 495 299 A1 or Vogdanis, L.; Heitz, W., Die Makromolekulare Chemie, Rapid Communications 1986, 7 (9), 543-547).

Disadvantages of these catalysts include for example that organotin compounds have recently been recognized as being harmful to human health. It is therefore undesirable for such catalysts to remain in the polyether carbonate alcohol.

Known alternative catalysts include inter alia the abovementioned alkali metal carbonates or acetates but also sodium dihydrogen phosphate (Pawlowski, P.; Rokicki, G. Synthesis of oligocarbonate diols from ethylene carbonate and aliphatic diols catalyzed by alkali metal salts. Polymer 2004, 45, 3125-3137). However, the disadvantage of sodium dihydrogen phosphate as catalyst for the addition reaction of cyclic carbonates onto H-functional starter substances is the lower conversion compared to alkali metal carbonates for example.

It is known from WO2015/014732 that the addition of compounds containing a phosphorus-oxygen bond to polyether carbonate alcohols reduces the formation of by-products during thermal storage of polyether carbonate alcohols. It would therefore be desirable to be able to use a catalyst containing a phosphorus-oxygen bond which can remain in the product.

U.S. Pat. No. 3,248,414 A discloses that in the preparation of polyether carbonate alcohols by addition reaction of cyclic carbonates onto H-functional starter substances Na₃PO₄ may be employed as catalyst. An effect of other tribasic phosphates on the conversion of cyclic carbonates and the proportion of incorporated CO₂ groups is not disclosed in U.S. Pat. No. 3,248,414 A.

### SUMMARY

It is accordingly an object of the present invention to provide a process for preparing polyether carbonate alcohols with a catalyst containing a phosphorus-oxygen bond which results in a high conversion of the cyclic carbonates and in a high proportion of incorporated CO₂ groups.

It has been found that, surprisingly, the technical object of the invention is achieved by a process for preparing polyether carbonate alcohols by addition reaction of cyclic carbonate onto an H-functional starter substance in the presence of a catalyst, characterized in that

the catalyst employed is a tribasic alkali or alkaline earth metal phosphate,

wherein the alkali metal is selected from potassium or cesium.

### DETAILED DESCRIPTION

The process may comprise first initially charging the reactor with an H-functional starter substance and cyclic carbonate. It is also possible to initially charge the reactor with only a subamount of the H-functional starter substance and/or a subamount of the cyclic carbonate. The amount of catalyst required for the ring-opening polymerization is then optionally added to the reactor. The sequence of addition is not critical. It is also possible to charge the reactor first with the catalyst and then with an H-functional starter substance and cyclic carbonate. It is alternatively also possible to first suspend the catalyst in an H-functional starter substance and then charge the reactor with the suspension.

The catalyst is preferably used in an amount such that the content of catalyst in the resulting reaction product is 10 to 50000 ppm, particularly preferably 250 to 30000 ppm, and most preferably 1000 to 25000 ppm. The catalyst content is preferably determined by elemental analysis by inductively coupled plasma optical emission spectroscopy (ICP-OES).

In a preferred embodiment inert gas (for example argon or nitrogen) is introduced into the resulting mixture of (a) a subamount of H-functional starter substance, (b) catalyst and (c) cyclic carbonate at a temperature of 30° C. to 120° C., particularly preferably of 40° C. to 100° C.

In an alternative preferred embodiment, the resulting mixture of (a) a subamount of H-functional starter substance, (b) catalyst and (c) cyclic carbonate is subjected at least once, preferably three times, at a temperature of 30° C. to 120° C., particularly preferably of 40° C. to 100° C., to 1.5 bar to 10 bar (absolute), particularly preferably 3 bar to 6 bar (absolute), of an inert gas (for example argon or nitrogen) and then the gauge pressure is reduced in each case to about 1 bar (absolute).

The catalyst may be added in solid form or as a suspension in cyclic carbonate, in H-functional starter substance or in a mixture thereof.

In a further preferred embodiment in a first step a subamount of the H-functional starter substances and cyclic carbonate are initially charged and in a subsequent second step the temperature of the subamount of H-functional starter substance and of the cyclic carbonate is brought to 40° C. to 120° C., preferably 40° C. to 100° C., and/or the pressure in the reactor is reduced to less than 500 mbar, preferably 5 mbar to 100 mbar, wherein optionally an inert gas stream (for example of argon or nitrogen) is applied and the catalyst is added to the subamount of H-functional starter substance in the first step or immediately thereafter in the second step.

The resulting reaction mixture is then heated for example at a temperature of 110° C. to 220° C., preferably 130° C. to 200° C., particularly preferably 140° C. to 180° C., with optional passing of an inert gas stream (for example of argon or nitrogen) through the reactor. The reaction is continued until no more gas evolution is observed at the established temperature. The reaction may likewise be carried out under pressure, preferably at a pressure of 50 mbar to 100 bar (absolute), particularly preferably 200 mbar to 50 bar (absolute), particularly preferably 500 mbar to 30 bar (absolute).

If the reactor has only been initially charged with a subamount of H-functional starter substance and/or a subamount of cyclic carbonate, the metered addition of the remaining amount of H-functional starter substance and/or cyclic carbonate into the reactor is carried out continuously. It is possible to effect metered addition of the cyclic carbonate at a constant metering rate or to increase or lower the metering rate gradually or stepwise or to add the cyclic carbonate portionwise. The cyclic carbonate is preferably added to the reaction mixture at a constant metering rate. The metered addition of the cyclic carbonate or of the H-functional starter substances may be effected simultaneously or sequentially in each case via separate metering points (addition points) or via one or more metering points where metered addition of the H-functional starter substances may be effected individually or as a mixture.

In the process the cyclic carbonates may be employed individually or as mixtures. The cyclic carbonate employed is preferably cyclic propylene carbonate (cPC), cyclic ethylene carbonate (cEC) or a mixture of both, particularly preferably just cyclic ethylene carbonate.

The polyether carbonate alcohols may be prepared in a batch, semi-batch or continuous process. It is preferable when the polyether carbonate alcohols are prepared in a continuous process which comprises both a continuous copolymerization and a continuous addition of the H-functional starter substance.

The invention therefore also provides a process, wherein H-functional starter substance, cyclic carbonate and catalyst are continuously metered into the reactor and wherein the resulting reaction mixture (containing the reaction product) is continuously removed from the reactor. The catalyst is preferably suspended/dissolved in H-functional starter substance and added continuously.

The term “continuously” used here can be defined as the mode of addition of a relevant catalyst or reactant such that an essentially continuous effective concentration of the catalyst or the reactant is maintained. The feeding of the catalyst and the reactants may be effected in a truly continuous manner or in relatively tightly spaced increments. Equally, continuous starter addition may be effected in a truly continuous manner or in increments. There would be no departure from the present process in adding a catalyst or reactants incrementally such that the concentration of the materials added drops essentially to zero for a period of time before the next incremental addition. However, it is preferable for the catalyst concentration to be kept substantially at the same concentration during the main portion of the course of the continuous reaction, and for starter substance to be present during the main portion of the copolymerization process. An incremental addition of catalyst and/or reactant which does not substantially influence the nature of the product is nevertheless “continuous” in that sense in which the term is being used here. It is possible, for example, to provide a recycling loop in which a portion of the reacting mixture is recycled to a prior point in the process, thus smoothing out discontinuities caused by incremental additions.

H-Functional Starter Substance

Suitable H-functional starter substances (starters) that may be used are compounds having alkoxylation-active H atoms which have a number-average molecular weight according to DIN55672-1 of up to 10000 g/mol, preferably up to 5000 g/mol and particularly preferably up to 2500 g/mol.

Alkoxylation-active groups having active H atoms are, for example, —OH (water, alcohols), —NH₂ (primary amines), —NH— (secondary amines), —SH and —CO₂H, preferably —OH, —NH₂ and —CO₂H, particularly preferably —OH. H-functional starter substances used are, for example, one or more compounds selected from the group consisting of mono- or polyhydric alcohols, polyfunctional amines, polyfunctional thiols, amino alcohols, thio alcohols, hydroxy esters, polyether polyols, polyester polyols, polyester ether polyols, polyether carbonate polyols, polycarbonate polyols, polycarbonates, polyethyleneimines, polyetheramines, polytetrahydrofurans (e.g. Poly THF® from BASF), polytetrahydrofuran amines, polyether thiols, polyacrylate polyols, castor oil, the mono- or diglyceride of ricinoleic acid, monoglycerides of fatty acids, chemically modified mono-, di- and/or triglycerides of fatty acids, and C₁-C₂₄ alkyl fatty acid esters containing an average of at least 2 OH groups per molecule and water. The C₁-C₂₄ alkyl fatty acid esters containing an average of at least 2 OH groups per molecule are for example commercial products such as Lupranol Balance® (from BASF AG), Merginol® products (from Hobum Oleochemicals GmbH), Sovermol® products (from Cognis Deutschland GmbH & Co. KG) and Soyol®™ products (from USSC Co.).

Monofunctional starter substances used may be alcohols, amines, thiols and carboxylic acids. Monofunctional alcohols used may be: methanol, ethanol, 1-propanol, 2-propanol, 1-butanol, 2-butanol, tert-butanol, 3-buten-1-ol, 3-butyn-1-ol, 2-methyl-3-buten-2-ol, 2-methyl-3-butyn-2-ol, propargyl alcohol, 2-methyl-2-propanol, 1-tert-butoxy-2-propanol, 1-pentanol, 2-pentanol, 3-pentanol, 1-hexanol, 2-hexanol, 3-hexanol, 1-heptanol, 2-heptanol, 3-heptanol, 1-octanol, 2-octanol, 3-octanol, 4-octanol, dodecanol, tetradecanol, hexadecanol, octadecanol, eicosanol, phenol, 2-hydroxybiphenyl, 3-hydroxybiphenyl, 4-hydroxybiphenyl, 2-hydroxypyridine, 3-hydroxypyridine, 4-hydroxypyridine. Suitable monofunctional amines include: butylamine, tert-butylamine, pentylamine, hexylamine, aniline, aziridine, pyrrolidine, piperidine, morpholine. Employable monofunctional thiols include: ethanethiol, 1-propanethiol, 2-propanethiol, 1-butanethiol, 3-methyl-1-butanethiol, 2-butene-1-thiol, thiophenol. Carboxylic acids include: formic acid, acetic acid, propionic acid, butyric acid, acrylic acid, oxalic acid, malonic acid, succinic acid, glutaric acid, adipic acid, pimelic acid, aromatic carboxylic acids such as benzoic acid, terephthalic acid, tetrahydrophthalic acid, phthalic acid or isophthalic acid, fatty acids such as stearic acid, palmitic acid, oleic acid, linoleic acid or linolenic acid.

Polyhydric alcohols suitable as H-functional starter substances are, for example, dihydric alcohols (for example ethylene glycol, diethylene glycol, propylene glycol, dipropylene glycol, propane-1,3-diol, butane-1,4-diol, butene-1,4-diol, butyne-1,4-diol, neopentyl glycol, pentane-1,5-diol, methylpentanediols (for example 3-methylpentane-1,5-diol), hexane-1,6-diol; octane-1,8-diol, decane-1,10-diol, dodecane-1,12-diol, bis(hydroxymethyl)cyclohexanes (for example 1,4-bis(hydroxymethyl)cyclohexane), triethylene glycol, tetraethylene glycol, polyethylene glycols, dipropylene glycol, tripropylene glycol, polypropylene glycols, dibutylene glycol and polybutylene glycols); trihydric alcohols (for example trimethylolpropane, glycerol, trishydroxyethyl isocyanurate, castor oil); tetrahydric alcohols (for example pentaerythritol); polyalcohols (for example sorbitol, hexitol, sucrose, starch, starch hydrolyzates, cellulose, cellulose hydrolyzates, hydroxy-functionalized fats and oils, in particular castor oil), and all modification products of these aforementioned alcohols with different amounts of ε-caprolactone.

The H-functional starter substance may also be selected from the substance class of the polyether polyols having a molecular weight M. according to DIN55672-1 in the range from 18 to 8000 g/mol and a functionality of 2 to 3. Preference is given to polyether polyols formed from repeating ethylene oxide and propylene oxide units, preferably having a proportion of propylene oxide units of 35% to 100%, particularly preferably having a proportion of propylene oxide units of 50% to 100%. These may be random copolymers, gradient copolymers, alternating copolymers or block copolymers of ethylene oxide and propylene oxide.

The H-functional starter substance may also be selected from the substance class of the polyester polyols. The polyester polyols used are at least difunctional polyesters. Polyester polyols preferably consist of alternating acid and alcohol units. Acid components employed include, for example, succinic acid, maleic acid, maleic anhydride, adipic acid, phthalic anhydride, phthalic acid, isophthalic acid, terephthalic acid, tetrahydrophthalic acid, tetrahydrophthalic anhydride, hexahydrophthalic anhydride or mixtures of the acids and/or anhydrides mentioned. Alcohol components employed include, for example, ethanediol, propane-1,2-diol, propane-1,3-diol, butane-1,4-diol, pentane-1,5-diol, neopentyl glycol, hexane-1,6-diol, 1,4-bis(hydroxymethyl)cyclohexane, diethylene glycol, dipropylene glycol, trimethylolpropane, glycerol, pentaerythritol or mixtures of the alcohols mentioned. Employing dihydric or polyhydric polyether polyols as the alcohol component affords polyester ether polyols which can likewise serve as starter substances for preparation of the polyether carbonate polyols.

In addition, H-functional starter substances used may be polycarbonatediols which are prepared, for example, by reaction of phosgene, dimethyl carbonate, diethyl carbonate or diphenyl carbonate and difunctional alcohols or polyester polyols or polyether polyols. Examples of polycarbonates may be found, for example, in EP-A 1359177.

In a further embodiment of the invention, polyether carbonate polyols may be used as H-functional starter substances. More particularly, polyether carbonate polyols obtainable by the process according to the invention described here are used. To this end, these polyether carbonate polyols used as H-functional starter substances are prepared beforehand in a separate reaction step.

The H-functional starter substance generally has a functionality (i.e. number of polymerization-active H atoms per molecule) of 1 to 8, preferably of 1 to 3. The H-functional starter substance is used either individually or as a mixture of at least two H-functional starter substances.

It it is particularly preferable when the H-functional starter substance is at least one of compounds selected from the group consisting of water, ethylene glycol, propylene glycol, propane-1,3-diol, butane-1,3-diol, butane-1,4-diol, pentane-1,5-diol, 2-methylpropane-1,3-diol, neopentyl glycol, hexane-1,6-diol, octane-1,8-diol, diethylene glycol, dipropylene glycol, glycerol, trimethylolpropane, pentaerythritol, sorbitol, polyether carbonate polyols having a molecular weight Mₙ according to DIN55672-1 in the range from 150 to 8000 g/mol with a functionality of 2 to 3, and polyether polyols having a molecular weight Mₙ according to DIN55672-1 in the range from 150 to 8000 g/mol and a functionality of 2 to 3.

The H-functional starter substance is preferably chosen such that the obtained polyether carbonate alcohol is a polyether carbonate polyol, i.e. a polyether carbonate alcohol having a functionality of 2 or more.

Catalyst

According to the invention a tribasic alkali or alkaline earth metal phosphate is used as catalyst. The alkali metals of the catalyst are preferably selected from sodium, potassium or cesium, particularly preferably from sodium and potassium. The alkaline earth metals of the catalyst are preferably selected from calcium and magnesium. The catalyst is particularly preferably a tribasic alkali metal phosphate.

The polyether carbonate alcohols obtained by the process according to the invention may be subjected to further processing for example by reaction with di- and/or polyisocyanates to afford polyurethanes. Other possible applications are in washing detergent and cleaning product formulations, for example for textile or surface cleaning, drilling fluids, fuel additives, ionic and non-ionic surfactants, dispersants, lubricants, process chemicals for paper or textile production, cosmetic formulations, for example in skin or sun protection cream or hair care products.

Experimental Part

Experimentally determined OH numbers were determined according to the specification of DIN 53240-2 (November 2007).

The proportion of incorporated CO₂ in the resulting polyether carbonate alcohol (CO₂ content) was determined by ¹H-NMR spectroscopy (Bruker, AV III HD 600, 600 MHz; pulse program zg30, waiting time d1: 10 s, 64 scans). Each sample was dissolved in deuterated chloroform. The relevant resonances in the ¹H-NMR spectrum (based on TMS=0 ppm) are as follows:

For remaining monomeric ethylene carbonate (signal at 4.53 ppm) resulting from carbon dioxide incorporated into the polyether carbonate alcohol (resonances at 4.37-3.21 and in some cases 4.19-4.07 ppm—depending on the starter molecule selected), polyether polyol (i.e. without incorporated carbon dioxide) with resonances at 3.80-3.55 ppm.

The mole fraction of the carbonate incorporated in the polymer in the reaction mixture is calculated by formula (I) as follows, the following abbreviations being used:

F(4.53)=area of resonance at 4.53 ppm for cyclic carbonate (corresponds to four protons)

F(4.37-4.21)=area of resonance at 4.37-4.21 ppm for polyether carbonate alcohol.

F(4.19-4.07)=area of resonance at 4.19-4.07 ppm for polyether carbonate alcohol (sum of A(4.37-4.21) and A(4.19-4.07) corresponds to 4 protons)

F(3.8-3.55)=area of resonance at 3.8-3.55 ppm for polyether polyol (corresponds to 4 protons)

Taking account of the relative intensities the values for the polymer-bound carbonate (“linear carbonate” LC) in the reaction mixture were calculated in % by weight according to the following formula (I):

$${LC}_{wt . \%} = \frac{[ F ( 4.37 - 4.21 ) + F ( 4.19 - 4.07 ) ] \cdot 88}{N} \cdot 100 \% \qquad ( I )$$

wherein the value of N (“denominator” N) is calculated according to formula (II):

N=[(4.37-4.21)+F(4.19-4.07)]·88+F(3.8-3.55)·44 (II)

The factor 88 results from the sum of the molar masses of CO₂ (molar mass 44 g/mol) and of ethylene oxide (molar mass 44 g/mol); the factor 44 results from the molar mass of ethylene oxide.

The weight fraction (in % by weight) of CO₂ in the polyether carbonate alcohol was calculated according to formula (III):

$${{CO}_{2}}_{wt . \%} = {LC}_{wt . \%} \cdot \frac{44}{88} \qquad ( III )$$

The non-polymer constituents of the reaction mixture (i.e. unconverted cyclic ethylene carbonate) were mathematically eliminated to determine the composition based on the polymer proportion (consisting of polyether carbonate alcohol constructed from starter and cyclic ethylene carbonate) from the values of the composition of the reaction mixture. The weight fraction of the carbonate repeating units in the polyether carbonate alcohol was converted to a weight fraction of carbon dioxide using the factor F=44/(44+44) (see formula III). The figure for the CO₂ content in the polyether carbonate alcohol (“CO₂ incorporated”; see examples which follow) is normalized to the polyether carbonate alcohol molecule formed in the ring-opening polymerization.

The conversion of the reaction solution is calculated according to formula (IV) as follows, wherein the following abbreviations are used (shown for hexane-1,6-diol as the H-functional starter substance by way of example, the calculation was appropriately adapted for alternative starters):

F(1.78-1.29)=normalized area of resonance at 1.78-1.29 ppm for hexane-1,6-diol (defined as 8 protons)

F(4.36-3.20)=normalized area of resonance at 4.36-3.20 ppm for polyether carbonate alcohol and hexane-1,6-diol (remaining 4 protons).

It is apparent from the ratio of H-functional starter substance (e.g. hexane-1,6-diol: 12 H) to monomer that 31.57 protons from cEC are present in the reaction mixture (molar ratio of n(cEC)/n(1,6-HD)=7.89).

Taking into account the relative intensities conversion was calculated according to the following formula (IV):

$${Conversion}_{mol \%} = \frac{F ( 4.36 - 3.2 ) - \frac{F ( 1.78 - 1.29 )}{2}}{31.57} \cdot 100 \% \qquad ( IV )$$

Employed Raw Materials:

All chemicals listed were obtained from the recited manufacturer in the specified purity and used for the synthesis of polyether carbonate alcohols without further treatment.

| | |
|---|---|
| Potassium phosphate; K₃PO₄ | Sigma-Aldrich 97% |
| Cyclic ethylene carbonate (cEC): | Sigma-Aldrich 99% |
| Hexane-1,6-diol: | Sigma-Aldrich 99% |
| Glycerol: | Sigma-Aldrich 99%, anhydrous |
| Sodium dihydrogenphosphate | Sigma-Aldrich >99% |
| Disodium hydrogenphosphate | Sigma-Aldrich >99% |
| Sodium phosphate | Sigma-Aldrich >98 |
| Lithium phosphate | Sigma-Aldrich 98 |
| Sodium pyrophosphate | Sigma-Aldrich >95 |
| 1-Dodecanol | Sigma-Aldrich 98% |
| 1-Hexadecanol | Sigma-Aldrich ≥99% |

### EXAMPLE 1

### Preparation of Polyether Carbonate Alcohols Through Ring-Opening Polymerization of Cyclic Ethylene Carbonate in the Presence of Hexane-1,6-Diol as Starter and K₃PO₄ as Catalyst

A 500 mL four-necked glass flask was provided with a reflux condenser, KPG stirrer, temperature probe, nitrogen feed and gas outlet/discharge with pressure relief valve. 200 g of cyclic ethylene carbonate, 34.25 g of hexane-1,6-diol and 2.41 g of K₃PO₄ were then weighed in. For 30 minutes 10 L/h of nitrogen were introduced and the suspension stirred at 300 rpm. The suspension was then heated stepwise to 180° C. The resulting gas stream was discharged through a bubble counter downstream of the reflux condenser.

The reaction mixture was held at the established temperature until the gas evolution ceased. The completeness of the reaction was verified by IR spectroscopy through the complete disappearance of the two cEC C═O bands at 1850-1750 cm⁻¹.

The CO₂ proportion incorporated in the polyether carbonate alcohol was determined by ¹H-NMR spectroscopy by the methods described hereinabove.

The properties of the resulting polyether carbonate alcohol are shown in table 1.

### EXAMPLE 2

### Preparation of Polyether Carbonate Alcohols Through Ring-Opening Polymerization of Cyclic Ethylene Carbonate in the Presence of Hexane-1,6-Diol as Starter and Na₃PO₄ as Catalyst

The reaction was carried out analogously to example 1 with the exception that Na₃PO₄ (1.86 g) was employed as catalyst instead of K₃PO₄.

The properties of the resulting polyether carbonate alcohol are shown in table 1.

### EXAMPLE 3

### Preparation of Polyether Carbonate Alcohols Through Ring-Opening Polymerization of Cyclic Ethylene Carbonate in the Presence of H₂O as Starter and K₃PO₄ as Catalyst

The reaction was carried out analogously to example 1 with the exception that H₂O (3.9 g) was employed as starter instead of hexane-1,6-diol.

The properties of the resulting polyether carbonate alcohol are shown in table 1.

### EXAMPLE 4

### Preparation of Polyether Carbonate Alcohols Through Ring-Opening Polymerization of Cyclic Ethylene Carbonate in the Presence of 1-Dodecanol as Starter and K₃PO₄ as Catalyst

The reaction was carried out analogously to example 1 with the exception that 1-dodecanol (30.2 g) was employed as starter instead of hexane-1,6-diol and the amount of cEC was halved to 100 g of cEC.

The properties of the resulting polyether carbonate alcohol are shown in table 1.

### EXAMPLE 5

### Preparation of Polyether Carbonate Alcohols Through Ring-Opening Polymerization of Cyclic Ethylene Carbonate in the Presence of 1-Hexadecanol as Starter and K₃PO₄ as Catalyst

The reaction was carried out analogously to example 1 with the exception that 1-hexadecanol (39.3 g) was employed as starter instead of hexane-1,6-diol and the amount of cEC was halved to 100 g of cEC.

The properties of the resulting polyether carbonate alcohol are shown in table 1.

### EXAMPLE 6

### Preparation of Polyether Carbonate Alcohols Through Ring-Opening Polymerization of Cyclic Ethylene Carbonate in the Presence of Glycerol as Starter and K₃PO₄ as Catalyst

The reaction was carried out analogously to example 1 with the exception that glycerol (14.4 g) was employed as starter instead of hexane-1,6-diol.

The properties of the resulting polyether carbonate alcohol are shown in table 1.

### EXAMPLE 7

### Preparation of Polyether Carbonate Alcohols Through Ring-Opening Polymerization of Cyclic Ethylene Carbonate in the Presence of Hexane-1,6-Diol as Starter and NaH₂PO₄ as Catalyst

The reaction was carried out analogously to example 1 with the exception that NaH₂PO₄ (1.36 g) was employed as catalyst instead of K₃PO₄.

The properties of the resulting polyether carbonate alcohol are shown in table 1.

### EXAMPLE 8

### Preparation of Polyether Carbonate Alcohols Through Ring-Opening Polymerization of Cyclic Ethylene Carbonate in the Presence of Hexane-1,6-Diol as Starter and Na₂HPO₄ as Catalyst

The reaction was carried out analogously to example 1 with the exception that Na₂HPO₄ (1.61 g) was employed as catalyst instead of K₃PO₄.

The properties of the resulting polyether carbonate alcohol are shown in table 1.

### EXAMPLE 9

### Preparation of Polyether Carbonate Alcohols Through Ring-Opening Polymerization of Cyclic Ethylene Carbonate in the Presence of Hexane-1,6-Diol as Starter and H₃PO₄ as Catalyst

The reaction was carried out analogously to example 1 with the exception that H₃PO₄ (1.11 g) was employed as catalyst instead of K₃PO₄.

The properties of the resulting polyether carbonate alcohol are shown in table 1.

### EXAMPLE 10

### Preparation of Polyether Carbonate Alcohols Through Ring-Opening Polymerization of Cyclic Ethylene Carbonate in the Presence of Hexane-1,6-Diol as Starter and Na₄P₂O₂ as Catalyst

The reaction was carried out analogously to example 1 with the exception that Na₄P₂O₇ (3.02 g) was employed as catalyst instead of K₃PO₄.

The properties of the resulting polyether carbonate alcohol are shown in table 1.

### EXAMPLE 11

### Preparation of Polyether Carbonate Alcohols Through Ring-Opening Polymerization of Cyclic Propylene Carbonate in the Presence of Hexane-1,6-Diol as Starter and K₃PO₄ as Catalyst

A 500 mL four-necked glass flask was provided with a reflux condenser, KPG stirrer, temperature probe, nitrogen feed and gas outlet/discharge with pressure relief valve. 200 g of cyclic propylene carbonate, 34.25 g of hexane-1,6-diol and 2.08 g of K₃PO₄ were then weighed in. For 30 minutes 10 L/h of nitrogen were introduced and the suspension stirred at 300 rpm. The suspension was then heated stepwise to 180° C. The resulting gas stream was discharged through a bubble counter downstream of the reflux condenser.

The reaction mixture was held at the established temperature until the gas evolution ceased. The progress of the reaction was monitored by IR spectroscopy (cPC C═O band at 1790 cm⁻¹).

The CO₂ proportion incorporated in the polyether carbonate alcohol was determined by ¹H-NMR spectroscopy.

The properties of the resulting polyether carbonate alcohol are shown in table 2.

### EXAMPLE 12

### Preparation of Polyether Carbonate Alcohols Through Ring-Opening Polymerization of Cyclic Propylene Carbonate in the Presence of Hexane-1,6-Diol as Starter and Na₃PO₄ as Catalyst

The reaction was carried out analogously to example 11 with the exception that Na₃PO₄ (1.61 g) was employed as catalyst instead of K₃PO₄ and a reaction temperature of 200° C. was employed.

The properties of the resulting polyether carbonate alcohol are shown in table 2.

### EXAMPLE 13

### Preparation of Polyether Carbonate Alcohols Through Ring-Opening Polymerization of Cyclic Propylene Carbonate in the Presence of H₂O as Starter and K₃PO₄ as Catalyst

The reaction was carried out analogously to example 11 with the exception that H₂O (4.28 g) was employed as starter instead of hexane-1,6-diol.

The properties of the resulting polyether carbonate alcohol are shown in table 2.

### EXAMPLE 14

### Preparation of Polyether Carbonate Alcohols Through Ring-Opening Polymerization of Cyclic Propylene Carbonate in the Presence of Hexane-1,6-Diol as Starter and Na₂HPO₄ as Catalyst

The reaction was carried out analogously to example 11 with the exception that Na₂HPO₄ (1.39 g) was employed as catalyst instead of K₃PO₄ and a reaction temperature of 220° C. was employed.

TABLE 1

| Ex- | | | | CO₂ | Conversion |
|---|---|---|---|---|---|
| am- | Cycl. | | | [% by | (cEC) |
| ple | carbonate | Catalyst | Starter | wt.] | [%] |
| 1 | cEC | K₃PO₄ | hexane-1,6-diol | 15 | 99 |
| 2* | cEC | Na₃PO₄ | hexane-1,6-diol | 13 | 81 |
| 3 | cEC | K₃PO₄ | H₂O | 10 | 99 |
| 4 | cEC | K₃PO₄ | 1-dodecanol | 15 | 99 |
| 5 | cEC | K₃PO₄ | 1-hexadecanol | 16 | 99 |
| 6 | cEC | K₃PO₄ | glycerol | 8 | 99 |
| 7* | cEC | NaH₂PO₄ | hexane-1,6-diol | 21 | 29 |
| 8* | cEC | Na₂HPO₄ | hexane-1,6-diol | 21 | 16 |
| 9 | cEC | H₃PO₄ | hexane-1,6-diol | 17 | 8 |
| 10* | cEC | Na₄P₂O₇ | hexane-1,6-diol | 19 | 37 |

*comparative example

Table 1 shows the properties of the polyether carbonate alcohols prepared by addition reaction of cyclic ethylene carbonate onto an H-functional starter substance. It is apparent that the use of the catalysts according to the invention results in incorporation of CO₂ groups with a high conversion of cyclic ethylene carbonate. Examples 1 and 3 to 6 according to the invention all exhibit conversions of 99% cyclic ethylene carbonate while examples 2 and 7 to 10 without a catalyst according to the invention exhibit a conversion of less than 81% cyclic ethylene carbonate.

TABLE 2

| Ex- | | | | CO₂ | Conversion |
|---|---|---|---|---|---|
| am- | Cycl. | | | [% by | (cPC) |
| ple | carbonate | Catalyst | Starter | wt.] | [%] |
| 11 | cPC | K₃PO₄ | hexane-1,6-diol | 7 | 99 |
| 12* | cPC | Na₃PO₄ | hexane-1,6-diol | 6 | 75 |
| 13 | cPC | K₃PO₄ | H₂O | 4 | 99 |
| 14* | cPC | Na₂HPO₄ | hexanediol | 9 | 25 |

*comparative example

Table 2 shows the properties for the polyether carbonate alcohols prepared by addition reaction of cyclic propylene carbonate onto an H-functional starter substance. It is likewise apparent that the use of the catalysts according to the invention (examples 11 and 13) compared to a catalyst not according to the invention (examples 12 and 14) results in a high conversion of cyclic propylene carbonate.

1. A process for preparing polyether carbonate alcohols by addition reaction of cyclic carbonate onto an H-functional starter substance in the presence of a catalyst, wherein the catalyst employed is a tribasic alkali or alkaline earth metal phosphate,
wherein the alkali metal is selected from potassium or cesium.

2. The process as claimed in claim 1, wherein the alkaline earth metal is selected from calcium or magnesium.

3. The process as claimed in claim 1, wherein the catalyst is potassium phosphate.

4. The process as claimed in claim 1, wherein the cyclic carbonate employed is cyclic propylene carbonate, cyclic ethylene carbonate or a mixture of both cyclic propylene carbonate and cyclic ethylene carbonate.

5. The process as claimed in claim 1, wherein the addition reaction of the cyclic carbonate onto an H-functional starter substance is performed at a temperature in a range of 110° C. to 220° C.

6. The process as claimed in claim 1, wherein the H-functional starter substance has a number-average molecular weight according to DIN55672-1 of up to 10000 g/mol.

7. The process as claimed in claim 1, wherein the H-functional starter substance is at least one compound selected from the group consisting of water, ethylene glycol, propylene glycol, propane-1,3-diol, butane-1,3-diol, butane-1,4-diol, pentane-1,5-diol, 2-methylpropane-1,3-diol, neopentyl glycol, hexane-1,6-diol, octane-1,8-diol, diethylene glycol, dipropylene glycol, glycerol, trimethylolpropane, pentaerythritol, sorbitol, polyether carbonate polyols having a molecular weight Mₙ according to DIN55672-1 in the range from 150 to 8000 g/mol with a functionality of 2 to 3, and polyether polyols having a molecular weight Mₙ according to DIN55672-1 in the range from 150 to 8000 g/mol and a functionality of 2 to 3.

8. The process as claimed in claim 1, wherein the catalyst is present in a proportion of 10 to 50000 ppm based on the resulting reaction product.

9. The process as claimed in claim 1, wherein the process is performed under a nitrogen or argon atmosphere.

10. The process as claimed in claim 1, wherein the H-functional starter substance, cyclic carbonate and catalyst are continuously metered into the reactor.

11. The process as claimed in claim 10, wherein the resulting product is continuously removed from the reactor.

12. A polyether carbonate alcohol obtained by a process as claimed in claim 1.

13. A method comprising producing a polyurethane with the polyether carbonate alcohol as claimed in claim 12.

14. Washing detergent and cleaning product formulations, drilling fluids, fuel additives, ionic and non-ionic surfactants, dispersants, lubricants, process chemicals for paper or textile production, or cosmetic formulations comprising the polyether carbonate alcohol as claimed in claim 12.

15. The process as claimed in claim 5, wherein the addition reaction of the cyclic carbonate onto an H-functional starter substance is performed at a temperature in a range of 140° C. to 180° C.

16. The process as claimed in claim 6, wherein the H-functional starter substance has a number-average molecular weight according to DIN55672-1 of up to 2500 g/mol.

17. The process as claimed in claim 8, wherein the catalyst is present in a proportion of 1000 to 25000 ppm based on the resulting reaction product.
